(19) United States
(12) Patent Application Publication
(10) Pub. No.: US 2006/0269371 A1
(43) Pub. Date: Nov. 30, 2006

(54) Pipe-Tapering Device

(75) Inventor: John E. Cassity, Tooele, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: John E. Cassity, Tooele, UT (US)

(21) Appl. No.: 11/162,686

(22) Filed: Sep. 19, 2005

Related U.S. Application Data
(60) Provisional application No. 60/594,846, filed on May 11, 2005.

(51) Int. Cl. B23B 51/00

(52) U.S. Cl. 408/227

(57) ABSTRACT

The present invention is a cylindrical pipe-tapering device with angled interior blades designed to fit over a pipe end and shave the exterior rim of said end to a taper sufficient to allow practical insertion into a second pipe of the same size. The blades may be angled in relation to a cylindrical sidewall or the sidewall may be of conical form, thus angling the blades. The device is mountable on a hand-held power tool, such as a drill or a grinder, to allow maximum portability and simultaneous power. Holes may be fashioned in the sidewall of the device to reduce weight and drag, thus preserving more power from the power tool. Likewise, an external wall, or shield, may also be provided. The device is capable in many different sizes of manufacture, allowing for use on a multitude of pipe sizes. Alternatively, rasp plates may be used instead of blades. In further alternative versions, removable rasp plates or blades may be employed.

### CROSS-REFERENCES TO RELATED APPLICATIONS

The present Application is a non-provisional perfection of prior U.S. Provisional Application 60/594,846, filed May 11, 2005.

### FIELD OF THE INVENTION

The present invention relates to a device used in tapering pipes so as to fit pipes together easier and more particularly relates to a pipe tapering device that is easily attachable to present day portable power tools so as to increase mobility and utility.

### BACKGROUND OF THE INVENTION

Presently there are two main types of pipes used in modern plumbing applications, metal and plastic. Large plastic pipes, such as SDR or sewer pipes, are usually made of PVC and are assembled together by utilizing a gasket system. In this assembly system, one end, designated the bell end, is flanged and contains a gasket within the pipe's interior. The second, or spigot, end is inserted into the bell end of another pipe, after being coated with a lubricating compound to promote fitting. Usually, plastic pipes are fitted together by tapering a first pipe's spigot to better fit inside a second pipe's bell end without disrupting the gasket. The tapering process tends to be long and burdensome, however the advantage of tapering, that is lessening damage to the gasket within the second pipe's bell end, is seen as sufficient to warrant the time and effort. Some de-burring devices have been introduced into the prior art as a means to smooth cut pipe ends, and some of these de-burring devices do leave a slight taper; but, they are still cumbersome to use, as they are hand actuated, and the taper is so slight that its efficacy for eliminating the potential damage to a gasket is minimal. Since de-burring devices are designed for removing pieces of burred pipe, and not a whole pipe edge, they tend not to be sturdy enough for repeated and regular use and are impractical for obtaining an efficient taper for connection purposes, especially on larger pipes or in conjunction with mechanical actuation. In practice, de-burring devices are simply not used to taper pipes for these reasons. Instead, plumbers forego tapering or manually file pipe edges to obtain a proper taper.

What is needed, therefore, is a pipe-tapering device where the primary purpose is to taper pipe edges, not merely de-burr. As such, the device needs to be sturdy enough to withstand repeated use. What is also needed is a mechanical means of actuating the device so that extra work used in tapering does not fatigue the user. Due to the mobility and contortion of plumbing practice, the mechanical means and the device must be portable and small—easily maneuvered into the various positions a user may require. The device must also be capable of different sizes of manufacture, so as to accommodate different diameters of pipe, including larger pipe. The present invention provides for all of these needs.

### SUMMARY OF THE INVENTION

In view of the foregoing disadvantages inherent in the known methods and tools for pipe tapering, this invention provides an improved pipe-tapering device. As such, the present invention's general purpose is to provide a new and improved pipe-tapering device that will be both rugged to withstand repeated use for tapering purposes, mechanically driven for increased speed and efficiency, and portable for increased maneuverability.

To accomplish these goals, the pipe-tapering device of the present invention comprises a cylindrical body with a plurality of slots cut into the sidewall of the cylindrical body. The sidewall of the body, at the slots, is bent into the interior of the device at an angle and sharpened, forming angular tapering blades. Coaxial with the center axis of the cylindrical body is a tool interface, which may be of any type, for attachment onto a portable power tool, such as a drill or grinder. The interfaces may be categorized as either male, such as fitting into a drill chuck like a drill bit, or female, so as to fit on a grinder or similar device.

In use, the tool interface is attached to an appropriate power tool and the cylinder is fitted over the end of a length of pipe. The particular size of device is one sufficient to allow the device to slide unto the pipe while maintaining contact with the pipe's sidewall. The pipe should not be able to be inserted fully as the blades should prevent insertion without tapering. The attached power tool then actuates the device rotating it around the pipe end, shaving the exterior rim of the pipe to a smooth taper. In larger embodiments, the weight of the device may prove too much for some smaller power tools. Therefore, portions of the sidewall may be cut out to lessen the necessary torque to rotate the device. Likewise, an external wall may be provided for shielding, though out of mass considerations, the external wall should be much lighter than the internal, cutting, sidewall.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a side elevation of the present invention with a male tool interface.

FIG. 2 is a bottom plan view of the present invention, detailing the interior of the tool.

FIG. 3 is a top plan view of the present invention.

FIG. 4 is a cross-sectional view of the present invention, taken along line 4-4 in FIG. 2.

FIG. 5 is a side elevation of a tapered pipe, upon which the invention was used.

FIG. 6 is an end-on view of a pipe before tapering.

FIG. 7 is a top plan view of an alternate embodiment of the device according to the present invention with a female tool interface.

FIG. 8 is a bottom plan view of an alternate embodiment of the device according to the present invention utilizing rasp plates instead of blades.

FIG. 9 is a side elevation of an alternate embodiment of the present invention utilizing a tapered wall.

FIG. 10 is a bottom perspective view of an alternate embodiment of the present invention

FIG. 11 is a bottom perspective view of the invention in FIG. 10, taken at a different angle.

FIG. 12 is a top perspective view of the invention as depicted in FIG. 10.

FIG. 13 is a perspective view of yet another embodiment of the present invention.

### DETAILED DESCRIPTION OF THE PREFERRED EMBODIMENT

With reference now to the drawings, the preferred embodiment of the pipe-tapering device is herein described. It should be noted that the articles “a”, “an” and “the”, as used in this specification, include plural referents unless the content clearly dictates otherwise.

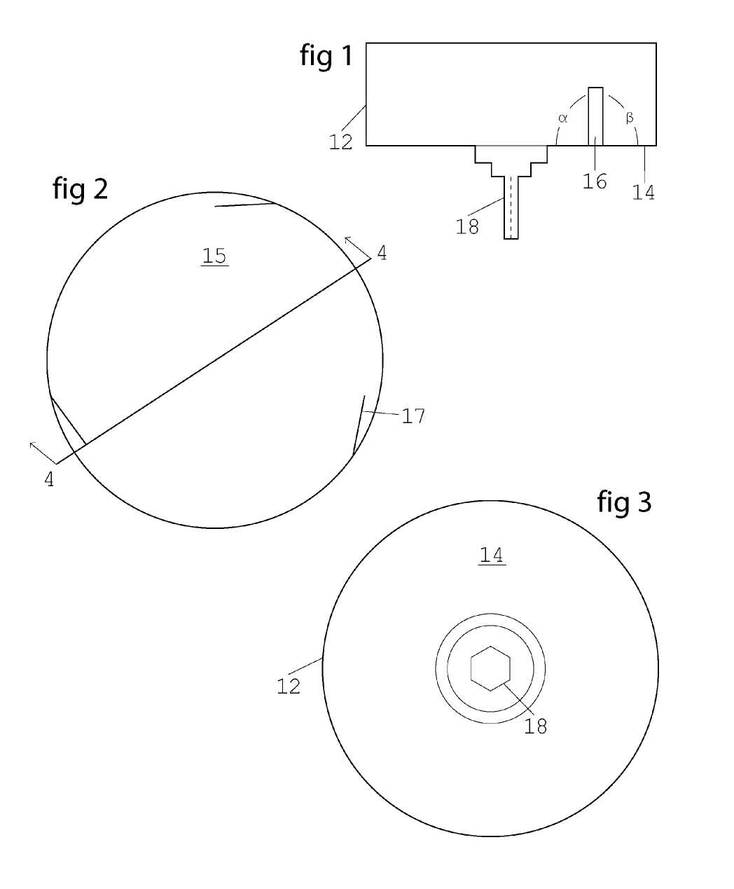

As seen in FIGS. 1 and 2, the preferred embodiment of the device is a cylindrical cap capable of fitting over a length of pipe. The body of the device is comprised of a lid 14 and a sidewall 12, defining an interior 15. A plurality of slots 16 is cut into sidewall 12, ideally having an equal arcuate distance between adjacent slots 16. The equal arcuate distance is desired to provide greater balance to the device when actuated.

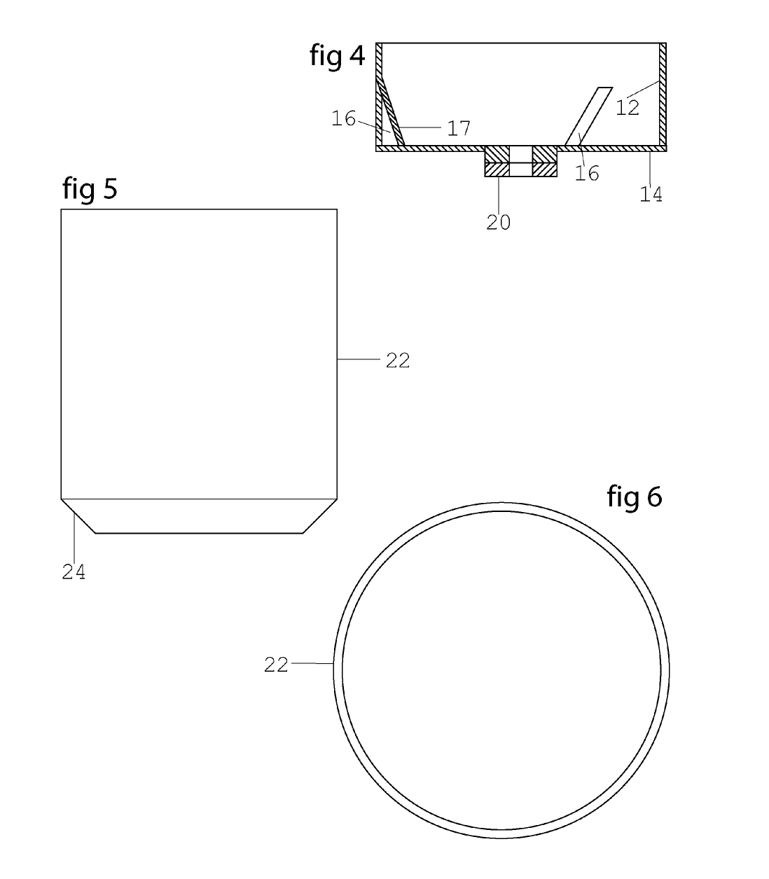

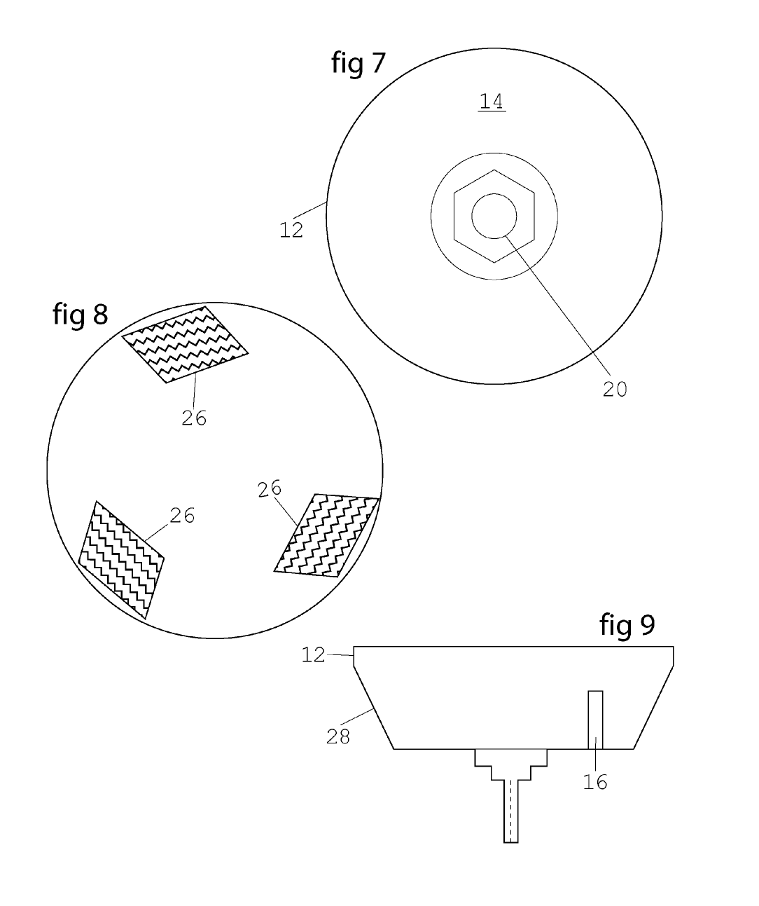

As seen in FIGS. 1 and 4, a tool interface is provided on lid 14, the interface extending opposite sidewall 12. In FIG. 1, the interface 18 is denominated as male and is suitable for insertion in a tool, such as a drill. In FIG. 4, the interface 20 is denominated as female and is suitable for mounting on tools such as a grinder. It should be intuitive, that larger pipes require larger devices and therefore greater driving force and increased stability. Use of the female device as shown in FIGS. 4 and 7, on a grinder for instance, provides that greater power and the interface provides greater stability than the male version of FIG. 1, though the male version is adequate for most needs. In either version, the interface is secured by conventional means, such as welding, to the lid 14.

Referring to FIG. 4, each of the slots 16 has its trailing edge turned into the interior of the cylinder 15, forming a blade 17. Ideally, the blade 17 is turned such that the distance from a given point on the blade 17 at a nearest point to a circumference defined by the sidewall 12 increases as the given point on the blade 17 is closer to the lid 14. It is also preferred that blade 17 is sharpened. In alternate embodiments, a plurality of filing or rasp plates 26, shown in FIG. 8, or a continuous rasp plate, may be used instead of a plurality of blades. Rasp plates 26 may be manufactured to be removable from sidewall 12 and lid 14, so as to facilitate longevity of the device at a lower cost. Similarly, removable blades may be used instead of rasp plates 28. Also, instead of angling blades 17, sidewall 12 may be angled 28 so that the device is more conical than cylindrical, though some cylindrical extension is desirable to guide and secure the device on a pipe end. This embodiment is shown in FIG. 9.

The preferred embodiment will vary, depending upon the size of the pipe being tapered. In any embodiment, the required rigidity and hardness for this invention will require it be made of metal, such as steel, or some other material of roughly equivalent hardness and durability. For a four-inch pipe, having an outside diameter of approximately 4.200 inches, the preferred embodiment of the tapering device will have an inside diameter of 4.280 inches and a height of approximately 1.700 inches. Three slots 16 should be provided, each being approximately 0.200 inches wide and about 1.000 inch in height from the lid 14 to the end of slot 16. Slot 16 may be angled to increase cutting efficiency. In FIG. 1, the measure of trailing angle α may be either acute, obtuse or right, though right is preferred, while the preferred leading angle β is supplementary with angle α, as a uniform slot is easier to manufacture than a non-uniform one. Angles α and β may, of course, be of any angle and may or may not be supplementary. The blade 17 should be angled inwards approximately 0.200 inches at its greatest extent, proximate lid 14. As a result of these dimensions, when the invention is used on a four-inch pipe, which has a usual wall thickness of 0.120 inches, pipe wall 22 will be tapered to 0.050 inches at its leading edge 24 over a course of approximately 0.600 inches, shown in FIGS. 5 and 6. For other sized pipes, modifications may be easily conceived and still the resultant device will fall within the scope of this invention. For larger pipes, additional slots 16 and blades 17 may be provided and the angles α and β may be adjusted for preference and efficiency. Likewise, the blade 17 may be turned inwards more or less than the dimension given to adjust taper and to adjust cutting ability, Likewise, blade 17 may also be turned inwards following a linear, quadratic, logarithmic or other function relating point on the blade 17 to nearest point on the circumference of the device defined by sidewall 12. Variations previously described in this specification would also apply.

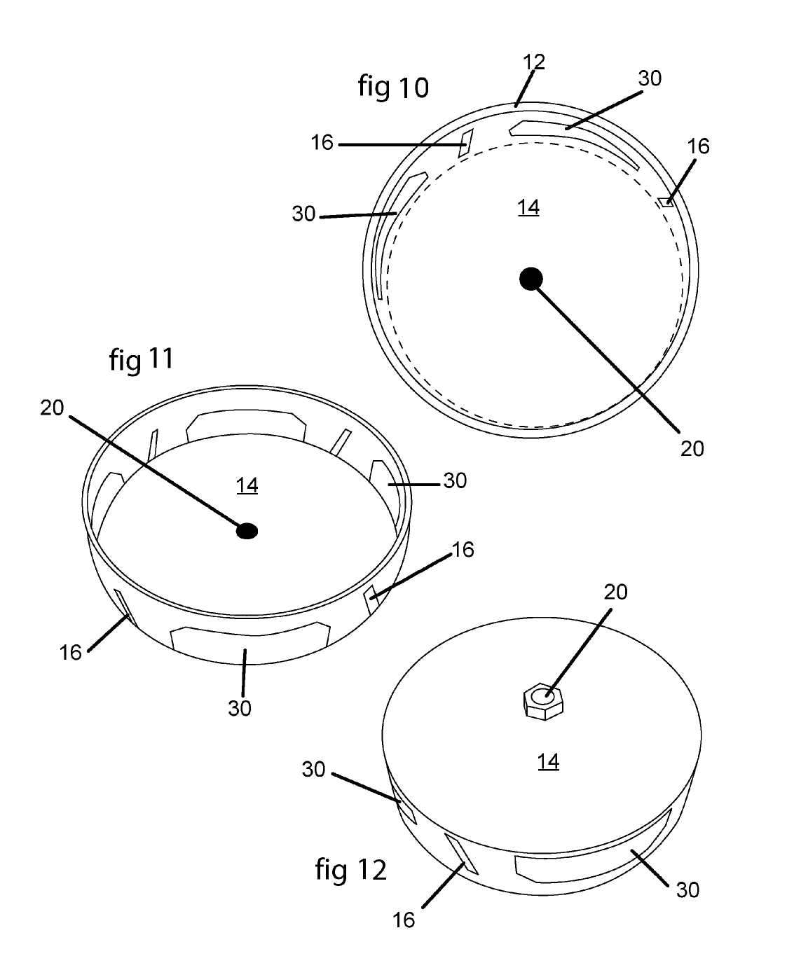

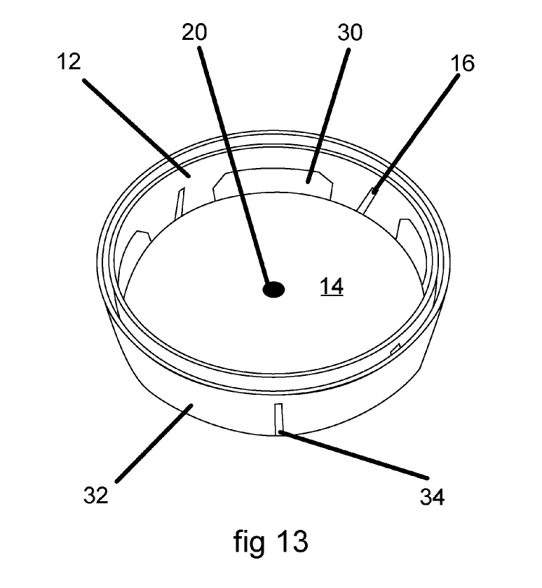

In a still further embodiment, shown in FIGS. 10-12, the mass of the device is reduced by the addition of mass control apertures 30. These apertures may be separate from cutting apertures 16, or may merely be cutting apertures 16 extended to eliminate mass. This arrangement is better suited for larger diameter devices, such as for 6-8 inch pipes or larger. In a still further embodiment, shown in FIG. 13, a thin but rigid external wall 32 is added to a lid 14 that extends beyond the sidewall 12. The external wall 32, then, prevents shavings and other debris from the tapering process from uncontrollably scattering about the tool. Instead, external wall 32 blocks such particles and allows a controlled exit through external aperture 34. Ideally, aperture 34 should be offset from any cutting apertures 16 in the sidewall 12. Though depicted on the later described embodiments, the external wall 32 may be applied to any embodiment herein described. When in use with the later, mass-lessened device depicted in FIGS. 10-12, the external wall is considerably thinner than sidewall 12, continuing to lessen overall mass while providing its shielding function. The walls may be manufactured together in any fashion; including spot welding the walls to the lid 14, and their preferred distance apart should be about ¼ inch. For a conical device, the shield wall 32 should likewise be a conical wall.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A pipe-tapering device comprising:
A means for mounting the device on a tool;
A cylindrical body, still further comprised of a closed first end, being attached to the mounting means and a circumferential sidewall with an edge, said closed end and sidewall defining an interior of the cylindrical body and the sidewall edge defining an open second end of the cylindrical body; and,
At least one cutting aperture in the sidewall, extending generally between the closed and open ends, the at least one cutting aperture having an annular rim, said rim having one edge turned into the interior of the cylindrical body such that a distance from a point on the turned-in edge of the rim to a nearest point on a circumference defined by the sidewall increases for points on the turned-in edge as the distance of said points to the closed end decreases.

2. The pipe-tapering device of claim 1 wherein the at least one cutting aperture is a plurality of cutting apertures, each being positioned along the sidewall such that an arcuate distance between consecutive cutting apertures is uniform.

3. The pipe-tapering device of claim 2, further comprising a trailing angle of incidence defined by the sidewall edge and each of the plurality of apertures being a right angle.

4. The pipe-tapering device of claim 2, further comprising a set of load-lessening apertures, each member of the set positioned between successive cutting apertures and having no rim turned into the interior of the cylindrical body.

5. The pipe-tapering device of claim 1, wherein the turned-in edge of the rim is sharpened.

6. The pipe-tapering device of claim 1, wherein the mounting means is selected from the set of mounting means consisting of male and female tool interfaces.

7. The pipe-tapering device of claim 1, a function by which the turned-in edge is turned into the interior of the device in relation to the circumference being selected from the set of functions consisting of linear functions, quadratic functions and hyperbolic functions.

8. The pipe-tapering device of claim 1, further comprising a trailing angle of incidence defined by the sidewall edge and the at least one aperture being a right angle.

9. The pipe-tapering device of claim 1, further comprising at least one load-lessening aperture having no rim turned into the interior of the cylindrical body.

10. The pipe-tapering device of claim 1, further comprising an external shield wall, coaxial with the cylindrical body and having a larger diameter than the same.

11. The pipe-tapering device of claim 10, further comprising at least one exit aperture in the shield wall.

12. A pipe-tapering device comprising:
A means for mounting the device;
A conical body, extending from the mounting means, with a closed first end of the device;
A cylindrical body, extending from the conical extension and having a circumferential sidewall with an edge said sidewall and conical extension defining an interior of the device and the edge defining an open end of the device; and,
At least one aperture in the conical extension, extending generally between the first and second ends, the at least one aperture having an annular rim, said rim having one edge turned into the interior of the device.

13. The pipe-tapering device of claim 12 wherein the at least one aperture is a plurality of apertures, each being positioned along the sidewall such that an arcuate distance between consecutive apertures is uniform.

14. The pipe-tapering device of claim 13, further comprising a trailing angle of incidence defined by the sidewall edge and each of the at least one aperture being a right angle.

15. The pipe-tapering device of claim 13, further comprising a set of load-lessening apertures, each member of the set positioned between successive cutting apertures and having no rim turned into the interior of the device.

16. The pipe-tapering device of claim 12, wherein the turned-in edge of the rim is sharpened.

17. The pipe-tapering device of claim 12, wherein the mounting means is selected from the set of mounting means consisting of male and female tool interfaces.

18. The pipe-tapering device of claim 12, further comprising a trailing angle of incidence defined by the sidewall edge and the at least one aperture being a right angle.

19. The pipe-tapering device of claim 12, further comprising at least one load-lessening aperture having no rim turned into the interior of the device.

20. The pipe-tapering device of claim 12, further comprising an external shield wall, coaxial with and external to the conical body and extending from the closed end.

21. The pipe-tapering device of claim 20, further comprising at least one exit aperture in the shield wall.

22. A pipe-tapering device comprising:
A means for mounting the device;
A cylindrical body, having an closed first end, being attached to the mounting means, and circumferential sidewall with an edge said closed end and sidewall defining an interior of the cylindrical body and the edge defining an open second end of the cylindrical body; and,
At least one means of tapering an inserted pipe, mounted within the interior of the cylinder.

23. The pipe-tapering device of claim 22, the means for tapering an inserted pipe being removable from the cylindrical body.

24. The pipe-tapering device of claim 23, the means for tapering an inserted pipe being chosen from means in the set of means consisting of rasp plates and blades.

25. The pipe-tapering device of claim 22, the means for tapering an inserted pipe being chosen from means in the set of means consisting of rasp plates and blades.
